(19) United States
(12) Patent Application Publication
(10) Pub. No.: US 2011/0164031 A1
(43) Pub. Date: Jul. 7, 2011

(54) NOVEL IMPLEMENTATION OF TOTAL VARIATION (TV) MINIMIZATION ITERATIVE RECONSTRUCTION ALGORITHM SUITABLE FOR PARALLEL COMPUTATION

(75) Inventor: Daxin SHI, VERNON HILLS, IL (US)

(73) Assignees: KABUSHIKI KAISHA TOSHIBA, TOKYO (JP); TOSHIBA MEDICAL SYSTEMS CORPORATION, OTAWARA-SHI (JP)

(21) Appl. No.: 12/683,250

(22) Filed: Jan. 6, 2010

(51) Int. Cl. G06T 15/00

(52) U.S. Cl. 345/419

(57) ABSTRACT

The CT imaging system optimizes its image generation by frequently updating an image and adaptively minimizing the total variation in an iterative reconstruction algorithm using many or sparse views under both normal and interior reconstructions. The projection data is grouped into N subsets, and after each of the N subsets is processed by the ordered subsets simultaneous algebraic reconstruction technique (OSSART), the image volume is updated. During the OSSART, no coefficients is cached in the system matrix. This approach is intrinsically parallel and can be implemented with a GPU card. Due to the more frequent image update and the variable step value, an image quality has improved.

### FIELD OF THE INVENTION

The current invention is generally related to an image processing and system, and more particularly related to optimize image generation by frequently updating an image and adaptively minimizing the total variation in an iterative reconstruction algorithm using many or sparse views under both normal and interior reconstructions.

### BACKGROUND OF THE INVENTION

For volume image reconstruction, an iterative algorithm has been developed by various groups such as in the three following examples. The University of Chicago group (Dr. Pan et. al.) proposed a total variation (TV) minimization iterative reconstruction algorithm for application to sparse views and limited angle x-ray CT reconstruction. The Virginia Technology group (Dr. Wang et. al.) published in 2009 a TV minimization algorithm aimed at region-of-interest (ROI) reconstruction with truncated projection data in many views, i.e., interior reconstruction problem. Although the disclosure by Virginia Technology is relevant, it is not prior art to the current invention since the conception date of the current invention precedes at least their publication date. Lastly, the University of Wisconsin at Madison group (Dr. Chen et. al.) proposed a prior image constrained compressed sensing (PICCS) method. Among the three prior art techniques, since the total variation (TV) is used for smoothing out noise in images and preserving edges in the same images, the total variation is to be minimized in order to optimize the above effects in image processing.

The following pseudocode illustrates one implementation as disclosed in Sidky and Pan, Phys. Med. Biol., Vol. 53, pp. 4777-4807, 2008.

```
  1: β := 1.0; β_{red} := 0.995;
  2: ng := 20; α := 0.2;
  3: rₘₐₓ := 0.95; α_{red} := 0.95;
  4: \vec{f} := 0
  5: repeat main loop (POCS/descent loop)
  6: \vec{f}₀ := \vec{f}
  $7 \text{:} for i = 1 , {N}_{d} do \text{:} {f}^{->} := {f }^{->} + β {{M}^{->}}_{i} \frac{{g}_{i} - {{M}^{->}}_{i} \cdot {f}^{->}}{{{M}^{->}}_{i} \cdot {{M}^{->}}_{i}} ART$
  8: for i = 1, Nᵢ do: if fᵢ < 0 then fᵢ = 0 enforce positivity
  9: \vec{f}ᵣₑₛ := \vec{f}
10: \tilde{g} := M \vec{f}
11: dd := |\tilde{g} − \tilde{g}₀|
12: dp := |\vec{f}− \vec{f}₀|
13: if {first iteration} then dtvg := α * dp
14: \vec{f}₀ := \vec{f}
15: for i =1, ng do TV-steepest descent loop
16:  \vec{d}f := ∇\vec{_{f}}∥ \vec{f} ∥_{TV}
17:   \hat{d}f := \vec{d} f /| \vec{d}f |
18:   \vec{f} := \vec{f} − dtvg * d\hat{ }f
19: end for
20: dg := | \vec{f} − \vec{f}₀|
21: if dg > rₘₐₓ * dp and dd > ε then dtvg := dtvg * α_{red}
22: β := β * β_{red}
23: until {stopping criteria}
24: return \vec{f}ᵣₑₛ
```

Despite the prior art efforts, some problems remain unsolved and require improvement. For example, since the University of Chicago group's technique is implemented using projection on convex set (POCS), the image processing cannot be implemented for parallel computation. This constraint is significant when applying their algorithm to 3D cone beam projection data with many views because it takes a long time to finish computation.

The University of Chicago approach requires the positivity constraint and a computationally intensive process. In fact, their approach updates the image volume for each ray. For example, for 90 views with 100 rays in each view, the University of Chicago approach updates the image 9000 times (90×100) before performing a first gradient descent step. In addition, in their TV minimization step, a fixed step size and a normalized gradient of the cost function are used for search direction. Since the step size is fixed generally at a very small value, the TV minimization step requires a large number of iterations. Lastly, the University of Chicago group's technique has an additional limitation of the positivity constraint that cannot be directly applied to some cases where the measured projection data assume negative data.

On the other hand, the Virginia Technology group implemented certain aspects of the image processing in parallel computation using projection data from many views in interior tomography, Ge Wang and Ming Jiang, J of X-Ray Science and Technology. Pp 169-177, 12 (2004). The parallel computation is based upon the ordered subset simultaneous algebraic reconstruction technique (OS-SART), and the SART and image update steps are repeated for each subset. That is, after the SART is performed only on a first subset, the image is immediately updated. These two sequential steps are repeated for each subset. In further details, in their SART step, the prior art technique needs to cache the coefficients of the system matrix.

The following pseudocode illustrates one implementation as disclosed in a later publication, Hengyong Yu and Ge Wang, Phys. Med. Biol. Pp. 2791-2805, 54 (2009). Although the relevant details of the pseudocode have been summarized below, the exact implementation will not be further discussed as they may not qualify as prior art.

1. α := 0.005, αₛ := 0.997, P_{TV} := 5;
2. k := 0, f_{m,n}⁰ := 0, P_{ART} := 20;
3. Repeat the main loop (OS-SART reconstruction and minimizing TV)
4. k := k + 1; f_{m,n}^{k} := f_{m,n}^{k-1}
5. For p_{art = 1 to P}_{ART} do
6. Update f_{m,n}^{k} by OS-SART using the projections in the pₐᵣₜ
subset;
7. For pₜᵥ = 1 to P_{TV} do
8. Computing the steepest decent direction d_{m,n};
9. β := max (| f_{m,n}^{k} |) ÷max(|d_{m,n}|);
10. f_{m,n}^{k} = f_{m,n}^{k} − α × β × d_{m,n} ;
11. α = α × αₛ ;
12. End for (pₜᵥ)
13. End for (pₐᵣₜ)
14. Until the stopping criteria are satisfied.

The inventor believes that although the 2009 Virginia Technology approach is aimed at interior reconstruction problem, their approach is an approximate solution to the interior problem because it has been shown there is no exact solution for this problem. The inventor also believes that the 2009 Virginia Technology approach is at best an ad hoc solution for high-contrast objects and has a lot of problems with low-contrast object imaging. Further, the inventor believes that their 2009 approach cannot be applied to a sparse view reconstruction problem which is the original merit of the TV minimization algorithm.

The approach by the University of Wisconsin group is disadvantageously limited. Their approach requires a set of prior images that may not be available in many cases. In addition, since their implementation is essentially based on projection on convex sets (POCS), their computation cannot be performed in parallel.

In view of the above discussed prior art problems, a practical solution is still desired for implementing a total variation (TV) minimization iterative reconstruction algorithm that is also suitable for parallel computation.

### SUMMARY OF THE INVENTION

In order to solve the above and other problems, according to a first aspect of the current invention, a method of optimizing image generation from projection data collected in a data acquisition device, including the steps of: a) grouping the projection data into a predetermined N subsets, each of the subsets N including a certain number of views; b) performing a ordered subset simultaneous algebraic reconstruction technique on the predetermined number of the views of one of the subsets N in a parallel manner; c) updating an image volume in the step b); d) repeating the steps b) and c) for every one of the subsets N; e) after the step d), determining a gradient step value according to a predetermined rule; and f) adaptively minimizing the total variation using the gradient step value as determined in the step e).

According to a second aspect of the current invention, a system for optimizing image generation, including: a data acquisition unit collecting projection data collected; and an image processing unit connected to the data acquisition unit for grouping the projection data into a predetermined N subsets, each of the subsets N including a certain number of views, the image processing unit performing a ordered subset simultaneous algebraic reconstruction technique on the predetermined number of the views of one of the subsets N in a parallel manner, the image processing unit performing an update on an image volume upon completion of the ordered subset simultaneous algebraic reconstruction technique, the image processing unit repeating the ordered subset simultaneous algebraic reconstruction technique and the update for every one of the subsets, upon completing every one of the subsets, the image processing unit determining a gradient step value according to a predetermined rule, the image processing unit adaptively minimizing the total variation using the gradient step value.

These and various other advantages and features of novelty which characterize the invention are pointed out with particularity in the claims annexed hereto and forming a part hereof. However, for a better understanding of the invention, its advantages, and the objects obtained by its use, reference should be made to the drawings which form a further part hereof, and to the accompanying descriptive matter, in which there is illustrated and described a preferred embodiment of the invention.

### BRIEF DESCRIPTION OF THE DRAWINGS

FIG. 1 is a diagram illustrating one embodiment of the multi-slice X-ray CT apparatus or scanner according to the current invention.

FIG. 2 is a flow chart illustrating steps involved in a preferred process of the Total Variation Iterative Reconstruction (TV-IR) according to the current invention.

FIG. 3 is a flow chart illustrating steps involved in the ordered subset simultaneous algebraic reconstruction technique (OS-SART) as used in a preferred process of the Total Variation Iterative Reconstruction (TV-IR) according to the current invention.

FIG. 4 is a flow chart illustrating steps involved in the line search technique as used in a preferred process of the Total Variation Iterative Reconstruction (TV-IR) according to the current invention.

FIG. 5 is a list of pseudocode illustrating one exemplary implementation of the steps involved in a preferred process of the Total Variation Iterative Reconstruction (TV-IR) according to the current invention.

FIG. 6 is a list of pseudocode illustrating one exemplary implementation of further steps of the steps S20 in FIG. 2 for the ordered subset simultaneous algebraic reconstruction technique (OS-SART) as used in a preferred process of the Total Variation Iterative Reconstruction (TV-IR) according to the current invention.

FIG. 7 is a list of pseudocode illustrating one exemplary implementation of further steps of the steps S30 in FIG. 2 for the line search technique as used in a preferred process of the Total Variation Iterative Reconstruction (TV-IR) according to the current invention.

### DETAILED DESCRIPTION OF THE PREFERRED EMBODIMENT(S)

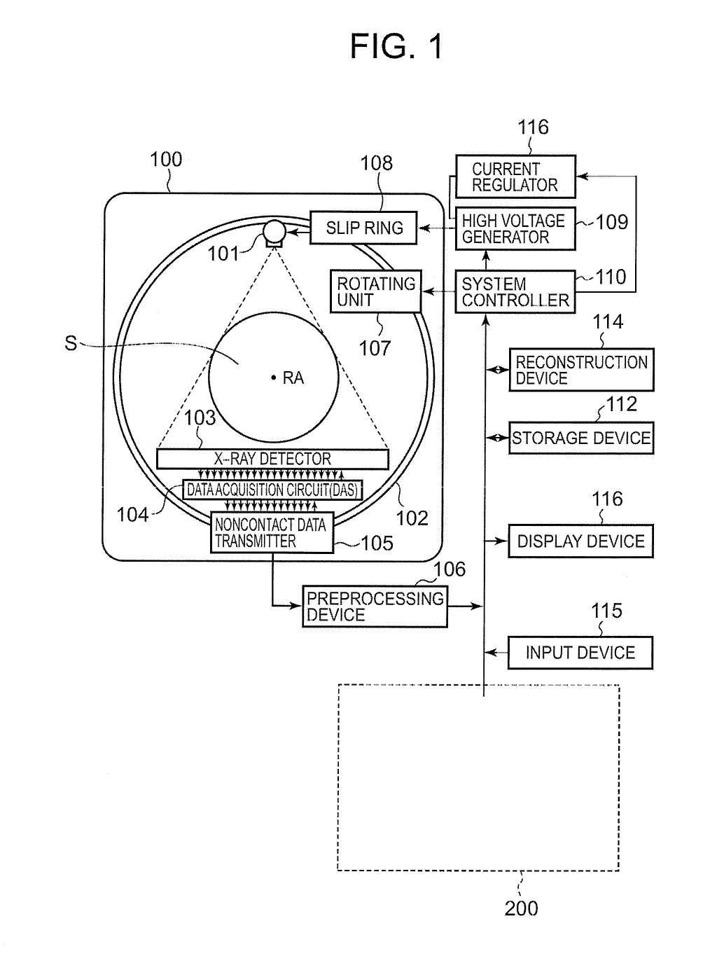

Referring now to the drawings, wherein like reference numerals designate corresponding structures throughout the views, and referring in particular to FIG. 1, a diagram illustrates one embodiment of the multi-slice X-ray CT apparatus or scanner according to the current invention including a gantry 100 and other devices or units. The gantry 100 is illustrated from a side view and further includes an X-ray tube 101, an annular frame 102 and a multi-row or two-dimensional array type X-ray detector 103. The X-ray tube 101 and X-ray detector 103 are diametrically mounted across a subject S on the annular frame 102, which is rotatably supported around a rotation axis RA. A rotating unit 107 rotates the frame 102 at a high speed such as 0.4 sec/rotation while the subject S is being moved along the axis RA into or out of the illustrated page.

The multi-slice X-ray CT apparatus further includes a high voltage generator 109 that applies a tube voltage to the X-ray tube 101 through a slip ring 108 so that the X-ray tube 101 generates X ray. The X rays are emitted towards the subject S, whose cross sectional area is represented by a circle. The X-ray detector 103 is located at an opposite side from the X-ray tube 101 across the subject S for detecting the emitted X rays that have transmitted through the subject S.

Still referring to FIG. 1, the X-ray CT apparatus or scanner further includes other devices for processing the detected signals from X-ray detector 103. A data acquisition circuit or a Data Acquisition System (DAS) 104 converts a signal output from the X-ray detector 103 for each channel into a voltage signal, amplifies it, and further converts it into a digital signal. The X-ray detector 103 and the DAS 104 are configured to handle a predetermined total number of projections per rotation (TPPR) that can be at the most 900 TPPR, between 900 TPPR and 1800 TPPR and between 900 TPPR and 3600 TPPR.

The above described data is sent to a preprocessing device 106, which is housed in a console outside the gantry 100 through a non-contact data transmitter 105. The preprocessing device 106 performs certain corrections such as sensitivity correction on the raw data. A storage device 112 then stores the resultant data that is also called projection data at a stage immediately before reconstruction processing. The storage device 112 is connected to a system controller 110 through a data/control bus, together with a reconstruction device 114, display device 116, input device 115, and the scan plan support apparatus 200. The scan plan support apparatus 200 includes a function for supporting an imaging technician to develop a scan plan.

One embodiment of the reconstruction device 114 further includes various software and hardware components. According to one aspect of the current invention, the reconstruction device 114 of the CT apparatus advantageously minimizes total variation (TV) using an iterative reconstruction technique suitable for parallel computation. In general, the reconstruction device 114 in one embodiment of the current invention operates the total volume iterative reconstruction (TVIR) algorithm, which performs on the projection data an ordered subset simultaneous algebraic reconstruction technique (OS-SART) step and a TV minimization step. The two steps are sequentially implemented in the main loop where a number of iterations were prescribed.

Before the TV minimization step, the projection data undergoes an ordered subsets simultaneous algebraic reconstruction technique (OS-SART). The projection data is grouped into a predetermined number of subsets N each having a certain number of views. During the ordered subsets simultaneous algebraic reconstruction technique (OS-SART), each subset may be sequentially processed in one embodiment. In another embodiment, a plurality of the subsets may be processed in parallel by taking advantage of certain microprocessor such as multiple central processing units (CPU) or a graphics processing unit (GPU).

During the ordered subsets simultaneous algebraic reconstruction technique (OS-SART), the reconstruction device 114 also performs two major operations. Namely, for each subset N, the reconstruction device 114 re-projects the image volume to form the computed projection data and back-projects the normalized difference between the measured projection and the computed projection data to reconstruct an updated image volume. In further detail, one embodiment of the reconstruction device 114 re-projects the image volume by using the ray tracing technique where no coefficient of the system matrix is cached. Moreover, one embodiment of the reconstruction device 114 simultaneously re-projects all rays in a subset, and this is optionally implemented in parallel. In the back-projection, one embodiment of the reconstruction device 114 uses a pixel-driven technique to back-project all of the normalized difference projection data in a subset to form the desired updated image volume. Because the reconstruction device 114 back-projects all ray sums, i.e., difference projection data, in a subset to form an image volume, this operation is optionally implemented in parallel too. These operations are applied to every subset N to complete a single OS-SART step. This and other embodiments are optionally included in the current scope of the invention as more particularly claimed in the appended claims.

In the total variation (TV) minimization step, one embodiment of the reconstruction device 114 employs a line search strategy to search a positive step size so as to ensure the objective function of the current image volume to be smaller than that of the previous image volume. According to this strategy, one embodiment of the reconstruction device 114 generates a variable step size in the TV minimization step in comparison to a fixed step size as seen in the prior art attempts discussed in the background prior art section. In addition, in the prior art Pan's approach, the search direction is a negative normalized gradient, while in one exemplary implementation of the current invention, the search direction is optionally not normalized.

One embodiment of the reconstruction device 114 adjusts a parameter called “TV steps” to balance the resolution and the noise. This adjustment operation is implemented in TV minimization step. One embodiment of the reconstruction device 114 repeats the TV minimization step X times where X is a predetermined number to suppress noise while sacrificing some resolution. One embodiment of the reconstruction device 114 advantageously determines a tradeoff between a resolution and noise level of this parameter.

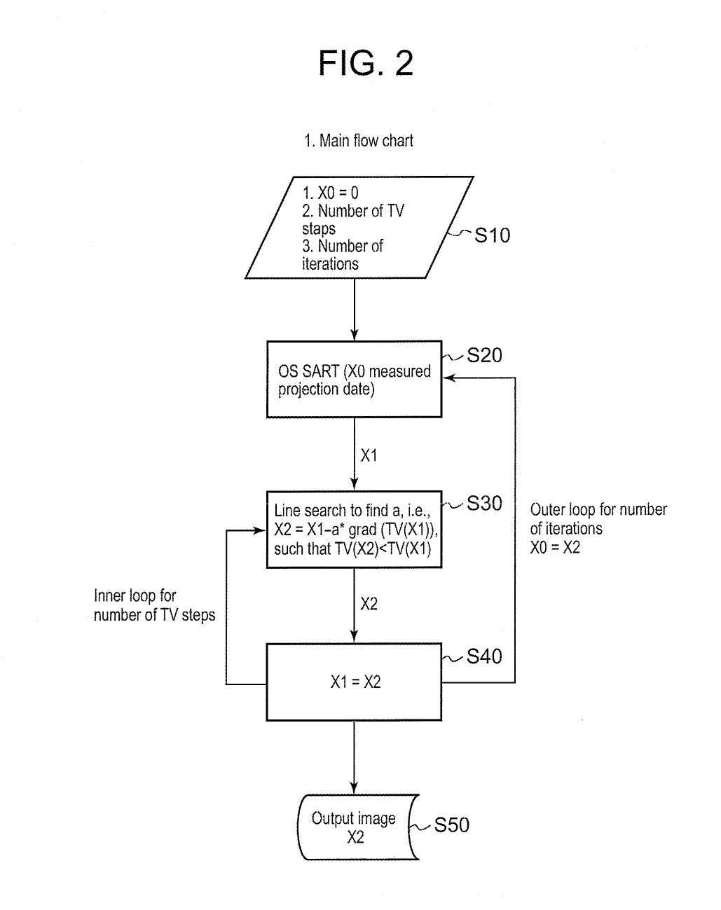

Now referring to FIG. 2, a flow chart illustrates steps involved in a preferred process of the Total Variation Iterative Reconstruction (TV-IR) according to the current invention. The illustrated preferred process includes two loops where certain steps are repeated and iteratively performed. The first or outer loop includes steps S20, S30 and S40. The second or inner loop includes the steps S30 and S40. These loops are repeated respectively according to a first and second predetermined numbers rather than a certain condition is met. The steps S20 and S30 are repeated in the inner loop for the first predetermined number of times as the predetermined number of TV step is initialized in the step S10. When the inner loop is finished, the steps S20 through S40 are repeated in the outer loop for the second predetermined number of times as the predetermined number of iterations is initialized in the step S10.

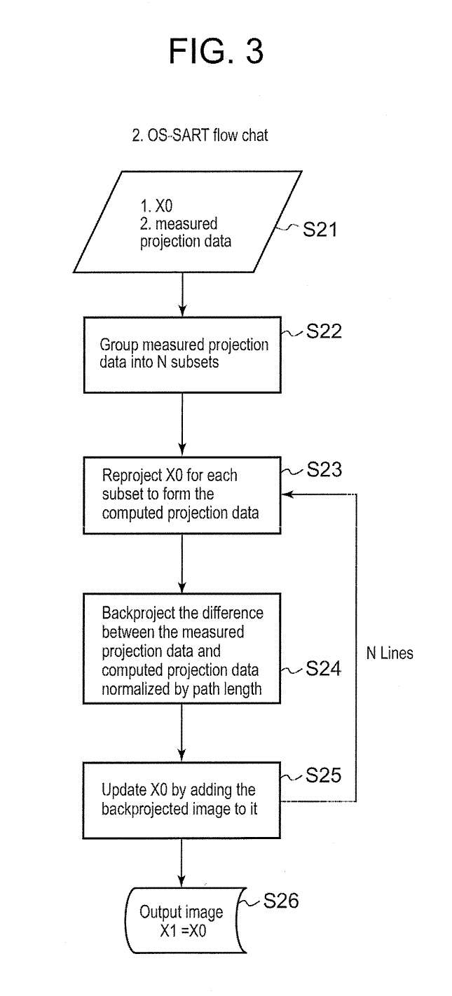

Still referring to FIG. 2, each of the steps S10 through S50 is generally described below. In an initialization step S10, image X0 is initialized to 0. In the same step, a number of TV step is initialized to a first predetermined number while a number of iterations is initialized to a second predetermined number. As will be further discussed, these predetermined numbers are generally determined in an empirical manner. In a step S20, the ordered subset simultaneous algebraic reconstruction technique (OS-SART) is performed on the measured projection data in a preferred process of the Total Variation Iterative Reconstruction (TV-IR) according to the current invention. The step S20 outputs an intermediate image X1. The detailed steps of the OS-SART will be further described with respect to FIG. 3 below. In a subsequent step S30, a line search method is iteratively performed in order to minimize the total variation based upon the predetermined number of TV steps. As the step 30 is finished, an image X2 is generated from the intermediate image X1 from the step S20. The image generated in the step S30 is assigned to an intermediate image holder or variable X1 in a step S40 before the outer loop is repeated from the step 20 or before the image X2 is outputted in a step S50.

Now referring to FIG. 3, a flow chart illustrates further steps of the steps S20 in FIG. 2, and these steps are involved in the ordered subset simultaneous algebraic reconstruction technique (OS-SART) as used in a preferred process of the Total Variation Iterative Reconstruction (TV-IR) according to the current invention. The illustrated preferred process of the OS-SART includes one loop where certain steps are repeated and iteratively performed. The loop includes steps S23, S24 and S25 and is repeated according to a predetermined number N rather than a certain condition is met. When the loop is finished, the OS-SART outputs the intermediate image in the variable X1.

Still referring to FIG. 3, each of the steps S21 through S26 is generally described below. In a step S21, the image X0 and measured projection data p are availed from through the step S20 of FIG. 2. In a step S22, the measured projection data p is partitioned into Nₛₑₜₛ groups called subsets. Each of the subsets N contains N_{subrays}=N_{rays}/Nₛₑₜₛ ray sums. For each of the subsets N, a step S23 re-projects the image X0 to form the computed projection data while a step S24 back-projects the normalized difference between the measured projection data and the computed projection data. In further detail, one embodiment of the step S23 re-projects the image volume by using the ray tracing technique where no coefficient of the system matrix is cached. Moreover, one embodiment of the step S23 simultaneously re-projects all rays in a subset, and this is optionally implemented in parallel. In the back-projection, one embodiment of the S24 uses a pixel-driven technique to back-project all of the normalized difference projection data in a subset to form the desired updated image volume. Because the step S24 back-projects all ray sums, i.e., the normalized difference projection data, in a subset to form an image volume, this operation is optionally implemented in parallel. These operations are applied to every subset N to complete a single OS-SART step. Finally, a step S25 updates the image X0 by adding the back-projected image from the step S24 to the image X0. The image generated in the step S25 is assigned to an intermediate image holder or variable X1 in a step 26 before the loop is repeated by proceeding to the step 23 or before the image X1 is outputted in a step S26.

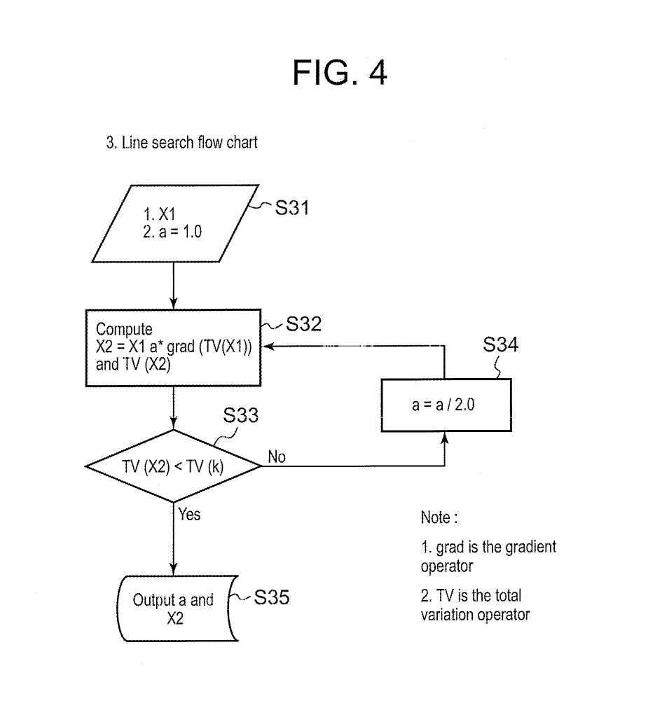

Now referring to FIG. 4, a flow chart illustrates further steps of the steps S30 in FIG. 2, and these steps are involved in the line search technique as used in a preferred process of the Total Variation Iterative Reconstruction (TV-IR) according to the current invention. The illustrated preferred process of the line search technique includes one loop where certain steps are repeated and iteratively performed. The loop includes steps S32, S33 and S34 and is repeated according to a predetermined number of times rather than a certain condition is met. When the loop is finished, the line search technique returns the image in the variable X2 and the step size variable a.

Still referring to FIG. 4, each of the steps S31 through S35 is generally described below. In a step S31, the image X1 is availed from the step S20 through the step S30 of FIG. 2. In addition, in the same step, a step size variable a is initialized to a predetermined value such as 1.0. In a step S32, the image X2 is computed according to the equation, X1−a*grad(TV(X1)), where a is the step size variable, grad is a predetermined gradient operator, and TV is a predetermined total variation operator. Similarly, in the same step, after the image variable X2 has been newly assigned, TV(X2) is computed where TV is the same predetermined total variation operator. In a step S33, the previously obtained values of TV(X2) and TV(X1) are compared. If TV(X2)<TV(X1) is not true, the current step size value is reduced to a half in a step S34, the line search method continues to the step S32. On the other hand, if TV(X2)<TV(X1) is true, the current step size value a and the image X2 are outputted in a step S35. In other words, the above described steps S32, S33 and S34 are repeated until TV(X2)<TV(X1) becomes true.

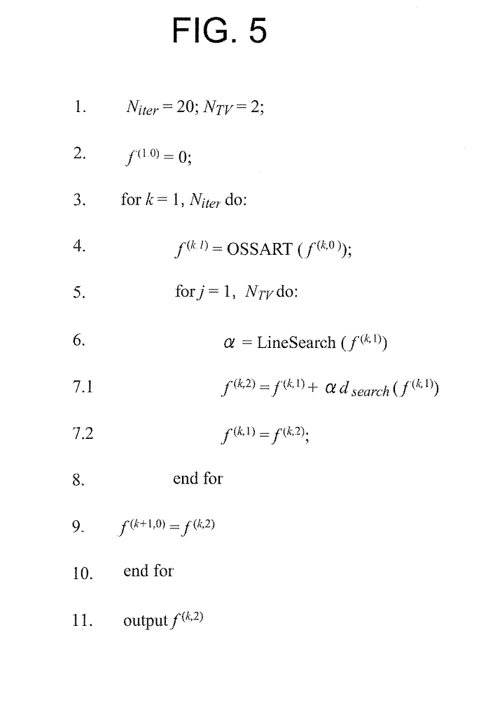

FIG. 5 is a list of exemplary pseudocode is illustrated for implementing the steps involved in a preferred process of the Total Variation Iterative Reconstruction (TV-IR) according to the current invention. The main procedure has two parameters to determine the number of iterations in lines 3 through 10 and the number of the total variation (TV) steps in lines 5 through 8 so as to control the image appearance. The predetermined number of the repeated TV steps is used to generally suppress a noise level. In the pseudocode, the number of iterations and the number of TV steps are respectively denoted by Nᵢₜₑᵣ and N_{TV}. In general, Nᵢₜₑᵣ is inversely proportional to the number of projection views while N_{TV}, is proportional to the noise level. Note that no clear convergence criteria are defined to terminate the program. In stead, the program iterates a certain predetermined number of times before it stops.

In one exemplary implementation, if the number of views is more than 900 and the projection data is generally clean, Nᵢₜₑᵣ is optionally set to 20 while N is set to 1. On the other hand, if the projection data is very noisy, N_{TV} is optionally set to a value ranging from 3 to 9. In fact, in certain situations, N_{TV}, is optionally set to a value over 9. In general, the larger N_{TV}, the smoother the reconstructed image becomes while spatial resolution may be sacrificed.

Still referring to FIG. 5, the exemplary pseudocode uses the following notations for a preferred process of the Total Variation Iterative Reconstruction (TV-IR) according to the current invention. To understand the pseudocode, an image f is expressed in the following equation (1) in terms of a system matrix A and projection data as denoted by a column vector p.

p=Af (1)

The image f has dimensions YDIM×XDIM for two-dimension (2D) and ZDIM×YDIM×XDIM dimensions for three-dimension (3D). Thus, the image is respectively represented by a 2D matrix f_{YDIM,XDIM} and a 3D matrix f_{ZDIM,YDIM,XDIM}. In describing the forward projection procedure, the image f is rearranged as a column vector that has YDIM×XDIM elements for 2D and ZDIM×YDIM×XDIM elements for 3D. Nₚᵢₓₗₜₛ is used to represent the total number of pixels in the image, i.e., Nₚᵢₓₑₗₛ=YDIM×XDIM in the 2D case and Nₚᵢₓₑₗₛ=ZDIM×YDIM×XDIM in the 3D case.

The projection data p has VIEWS or a number of projection views, and each of the VIEWS has rays that correspond to a number of CHANNELS in the 2D data. In addition, the 3D case, has a number of rays that corresponds to a product of CHANNELS×SEGMENTS, which indicates an additional dimension. Thus, if the total number of rays is denoted by N_{rays}, the 2D projection data has N_{rays}=VIEWS×CHANNELS while the 3D projection data has N_{rays}=VIEWS×SEGMENTS×CHANNELS. The projection data is denoted by the column vector p that has N_{rays} elements. The ith element of p is denoted by pᵢ which is the i^{th} ray sum.

The system matrix A is of dimension N_{rays}×Nₚᵢₓₑₗₛ and its entry is denoted by aᵢⱼ. Thus, the i^{th} ray sum can be represented as follows in Equation (2).

$${p}_{i} = {\sum }_{j = 1}^{Npixels} {a}_{ij} {f}_{j} . \qquad ( 2 )$$

It is costly to store all of the entries in the matrix A due to its huge dimension. For example, if 900 views are measured with 896 channels in each view and an image matrix of size 512×512 is to be reconstructed, the matrix A will have dimension 806, 400×262, 144. It should be noted that although the matrix A is sparse, it is still costly to store the entire matrix. One way to avoid storing the system matrix A is to compute the entries on the fly if we do not need its transpose. In one prior art approach, only the coefficients of one ray are computed and stored, and the image volume is updated for each ray. In one exemplary implementation according to the current invention, the system matrix A is not stored while we interpret its transpose as the back-projection operator.

The cost function (or objective function) is the total variation (TV) as defined below in Equation (3) for the 2D case and Equation (4) for the 3D case. The variable ε is a small quantity to prevent each term u(·) in the summation from vanishing because they will be divided in the formula of search direction. Note that Equations (3) and (4) represent the l¹ norm of a sequence of discrete gradient.

$$\begin{matrix}\begin{matrix}{U}_{TV} ( f ) = {\sum }_{k , l}^{ } \sqrt{{( {f}_{k + 1 , l} - {f}_{k , l} )}^{2} + {( {f}_{k , l + 1} - {f}_{k , l} )}^{2} + {ɛ}^{2}} \\ = {\sum }_{k , l}^{ } u ( k , l )\end{matrix} & ( 3 ) \\ \begin{matrix}{U}_{TV} ( f ) = {\sum }_{k , m , n}^{ } \sqrt{\begin{matrix}{( {f}_{k + 1 , m , n} - {f}_{k , m , n} )}^{2} + {( {f}_{k , m + 1 , n} - {f}_{k , m , n} )}^{2} + \\ {( {f}_{k , m , n + 1} - {f}_{k , m , n} )}^{2} + {ɛ}^{2}\end{matrix}} \\ = {\sum }_{k , m , n}^{ } u ( k , m , n )\end{matrix} & ( 4 )\end{matrix}$$

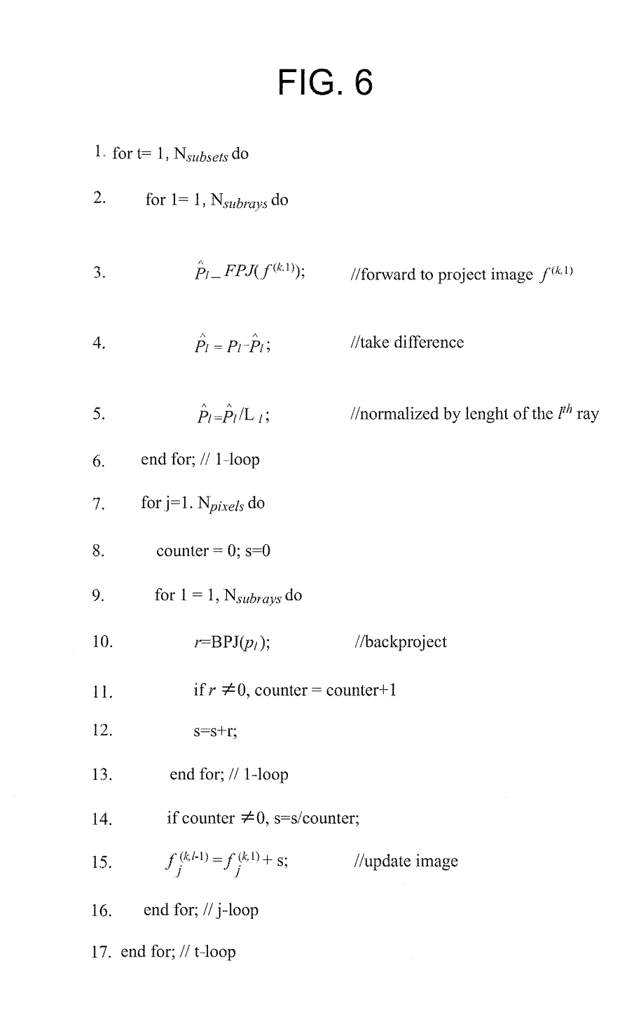

Now referring to FIG. 6, a list of exemplary pseudocode is illustrated for implementing further steps of the steps S20 in FIG. 2, and these steps are involved in the ordered subset simultaneous algebraic reconstruction technique (OS-SART) as used in a preferred process of the Total Variation Iterative Reconstruction (TV-IR) according to the current invention. In general, although the well studied OSSART has been considered, the exemplary implementation of the OSSART according to the current invention is a variant of projection on convex sets (POCS) as described in prior art. In the current implementation, the exemplary implementation is not intended to prove a particular OSSART is a correct POCS operation. The advantage of the OS-SART is that it is optionally implemented to be in parallel. In the exemplary implementation of the OS-SART, the system matrix A is not cached.

Still referring to FIG. 6, in the OS-SART, the projection data p is partitioned into Nₛₑₜₛ called subsets. The t^{th} subset is denoted by Sₜ, which contains N_{subrays}=N_{rays}/Nₛₑₜₛ ray sums. Mathematically, the update formula of OSSART is given by Equation (5) below:

$${f}_{j}^{( k , t + 1 )} = {f}_{j}^{( k , t )} + \frac{{\sum }_{l = 1}^{Nsubrays} {a}_{lj} \frac{pl - {\sum }_{m = 1}^{Npixels} {a}_{lm} {f}_{m}^{( k , t )}}{{\sum }_{m = 1}^{Npixels} {a}_{l , m}}}{{\sum }_{l = 1}^{Nsubrays} {a}_{lj}} , t = 1 , {…}_{Nsets} \qquad ( 5 )$$

where the coefficients of the system matrix A and the projection data p correspond to the rays in the subset Sₜ Note that although the transpose of the system matrix A is needed in the above formula, the exemplary implementation according to the current invention does not store the coefficients of system matrix A and treats the transpose operation as the back-projection operator. In Equation (5), the following three terms are further explained.

$${\hat{p}}_{l} ≡ {\sum }_{m = 1}^{Npixels} {a}_{lm} {f}_{m}^{( k , t )} \qquad ( 5 a )$$

The first term is the reprojection of the image f^{(k,t)}.

$${L}_{l} ≡ {\sum }_{m = 1}^{Npixels} {a}_{l , m} \qquad ( 5 b )$$

The second term is the length of lth ray.

$${C}_{l} ≡ {\sum }_{l = 1}^{Nsubrays} {a}_{lj} , \qquad ( 5 c )$$

The third term may be viewed as the number of times a particular j^{th} pixel has been back-projected.

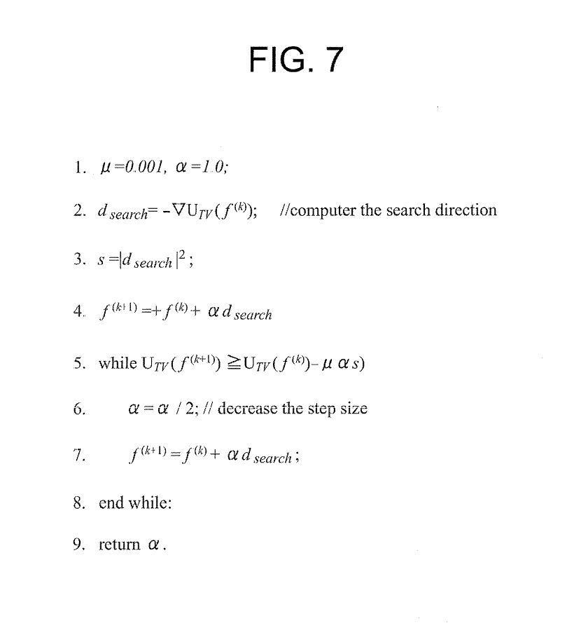

Now referring to FIG. 7, a list of exemplary pseudocode is illustrated for implementing further steps of the steps S30 in FIG. 2, and these steps are involved in the line search technique as used in a preferred process of the Total Variation Iterative Reconstruction (TV-IR) according to the current invention. The line search technique is employed to find a step size α, the step size α is used in the update formula as seen in Equation (6) or line 7.1 of the pseudocode in FIG. 5.

f^{(k+}1)=f^{(k)}+αd_{search}(f^{(k)}) (6)

such that U_{TV}(f^{(k+1)})≦(f^{(k)})+μαd_{search}^{T}∇U_{TV}(f^{(k)}, where μ is some scalar satisfying 0<μ<1. In the exemplary implementation, the value is set to μ=0.001.

The search direction is used in the gradient descent method to minimize the cost function as previously described in Equations (3) and (4). The search direction d_{search} is defined as:

d_{search}(f)=−∇U_{TV}(f) (7)

which is represented as a column vector of Nₚᵢₓₑₗₛ elements. This is shown by Equations (8) and (9) respectively for 2D and 3D.

$$\begin{matrix}\frac{\partial {U}_{TV} ( f )}{\partial {f}_{k , l}} = \frac{{f}_{k , l} - {f}_{k - 1 , l}}{u ( k - 1 , l )} + \frac{{f}_{k , l} - {f}_{k , l - 1}}{u ( k , l - 1 )} - \frac{{f}_{k + 1 , l} + {f}_{k , l + 1 -} 2 {f}_{k , l}}{u ( k , l )} \\ and & ( 8 ) \\ \frac{\partial {U}_{TV} ( f )}{\partial {f}_{k , m , n}} = \frac{{f}_{k - 1 , l , m , n} - {f}_{k , m , n}}{u ( k - 1 , m , n )} + \frac{{f}_{k , m - 1 , n - 1} - {f}_{k , m , n}}{u ( k , m - 1 , n )} + \frac{{f}_{k , m , n - 1} + {f}_{k , m , n}}{u ( k , m , n - 1 )} - \frac{{f}_{k + 1 , m , n} + {f}_{k , m + 1 , n} + {f}_{k , m , n + 1} - 3 {f}_{k , m , n}}{u ( k , m , n )} & ( 9 )\end{matrix}$$

In the 2D case, only three terms in Equation (3), namely, u(k−1, l), u(k, l−1) and u(k, l), contain the variable f_{k,1} and these terms are differentiated only with respect to f_{k,l}to obtain with Equation (8).

It is to be understood, however, that even though numerous characteristics and advantages of the present invention have been set forth in the foregoing description, together with details of the structure and function of the invention, the disclosure is illustrative only, and that although changes may be made in detail, especially in matters of shape, size and arrangement of parts, as well as implementation in software, hardware, or a combination of both, the changes are within the principles of the invention to the full extent indicated by the broad general meaning of the terms in which the appended claims are expressed.

What is claimed is:

1. A method of optimizing image generation from projection data collected in a data acquisition device, comprising the steps of:
a) grouping the projection data into a predetermined N subsets, each of the subsets N including a certain number of views;
b) performing a ordered subset simultaneous algebraic reconstruction technique on the predetermined number of the views of one of the subsets N in a parallel manner;
c) updating an image volume in said step b);
d) repeating said steps b) and c) for every one of the subsets N;
e) after said step d), determining a gradient step value according to a predetermined rule; and
f) adaptively minimizing the total variation using said gradient step value as determined in said step e).

2. The method of optimizing image generation according to claim 1, wherein said projection data has many views.

3. The method of optimizing image generation according to claim 1, wherein said projection data has sparse views.

4. The method of optimizing image generation according to claim 2 or 3, wherein said image generation is normal reconstruction.

5. The method of optimizing image generation according to claim 2 or 3, wherein said image generation is internal reconstruction.

6. The method of optimizing image generation according to claim 1, wherein said gradient step value is determined based upon a predetermined line search method.

7. The method of optimizing image generation according to claim 6, wherein said gradient step value ensures that an objective function of a current one of the image volume is smaller than that of a previous one of the image volume.

8. The method of optimizing image generation according to claim 1, wherein said step b) is performed by a graphics processing unit (GPU).

9. The method of optimizing image generation according to claim 1, wherein said step b) is performed by a central processing unit (CPU).

10. The method of optimizing image generation according to claim 1, wherein said step b) further includes additional steps of:
for each of said subsets N, re-projecting image volume to form computed projection data; and
back-projecting a normalized difference between measured projection and the computed projection data to reconstruct the image volume for update.

11. A system for optimizing image generation, comprising:
a data acquisition unit for obtaining projection data collected; and
an image processing unit connected to said data acquisition unit for grouping the projection data into a predetermined N subsets, each of the subsets N including a certain number of views, said image processing unit performing a ordered subset simultaneous algebraic reconstruction technique on the predetermined number of the views of one of the subsets N in a parallel manner, said image processing unit performing an update on an image volume upon completion of said ordered subset simultaneous algebraic reconstruction technique, said image processing unit repeating the ordered subset simultaneous algebraic reconstruction technique and the update for every one of the subsets, upon completing every one of the subsets, said image processing unit determining a gradient step value according to a predetermined rule, said image processing unit adaptively minimizing the total variation using the gradient step value.

12. The system for optimizing image generation according to claim 11, wherein said data acquisition unit collects the projection data in many views.

13. The system for optimizing image generation according to claim 11, wherein said data acquisition unit collects the projection data in sparse views.

14. The system for optimizing image generation according to claim 12 or 13, wherein said data acquisition unit collects the projection data for normal reconstruction.

15. The system for optimizing image generation according to claim 12 or 13, wherein said data acquisition unit collects the projection data for internal reconstruction.

16. The system for optimizing image generation according to claim 11, wherein said image processing unit determines the gradient step value based upon a predetermined line search method.

17. The system for optimizing image generation according to claim 16, wherein said image processing unit ensures the gradient step value so that an objective function of a current one of the image volume is smaller than that of a previous one of the image volume.

18. The system for optimizing image generation according to claim 11, wherein said image processing unit is a graphics processing unit (GPU).

19. The system for optimizing image generation according to claim 11, wherein said image processing unit is a central processing unit (CPU).

20. The system for optimizing image generation according to claim 11, wherein said image processing unit further performs the following:
for each of said subsets N, re-projecting image volume to form computed projection data; and
back-projecting a normalized difference between measured projection and the computed projection data to reconstruct the image volume for update.
